(19) United States
(12) Patent Application Publication
(10) Pub. No.: US 2020/0328858 A1
(43) Pub. Date: Oct. 15, 2020

(54) NETWORK CODED MULTIPATH SYSTEM AND RELATED TECHNIQUES

(71) Applicants: Massachusetts Institute of Technology, Cambridge, MA (US); Ecole Polytechnique Federale de Lausanne, Lausanne (CH); Northeastern University, Boston, MA (US)

(72) Inventors: Muriel Medard, Belmont, MA (US); Derya Malak, Boston, MA (US); Arno Schneuwly, Boesingen (CH); Emre Telatar, Epalinges (CH)

(21) Appl. No.: 16/758,210

(22) PCT Filed: Jul. 31, 2019
(86) PCT No.: PCT/US2019/044346

§ 371 Date: Apr. 22, 2020

Related U.S. Application Data
(60) Provisional application No. 62/712,428, filed on Jul. 31, 2018.

(51) Int. Cl. H04L 5/00; H04L 12/707; H04W 72/12

(52) U.S. Cl. CPC H04L 5/0046; H04W 72/12; H04L 45/24

(57) ABSTRACT

Techniques are disclosed for adaptive coding and scheduling of packets in wireless networks. The adaptive coding and scheduling can be achieved by utilizing a discrete water filling (DWF) scheme. In an example, a computer-implemented method to adaptively code and schedule packets in a wireless network may include determining number of paths between a sender and a receiver in a multipath (MP) network, determining erasure rates for each path of the paths between the sender and the receiver, and determining a multipath rate. The method may also include determining a coding bucket size based on the multipath rate and determining a multipath delay for the coding bucket size and the erasure rates. In another example, the adaptive coding and scheduling techniques can be applied to a multihop multipath (MM) network.

### CROSS-REFERENCE TO RELATED APPLICATION

This application claims the benefit of and priority to U.S. Provisional Patent Application No. 62/712,428, filed on Jul. 31, 2018, which is herein incorporated by reference in its entirety.

### BACKGROUND

Retransmission of lost packets is a capacity-achieving strategy in point-to-point communication under the assumption of perfect feedback, such as the case of lightly congested or highly reliable networks. However, feedback-based schemes are not well-suited to lossy wireless networks. Feedback may be unreliable or delayed in the case of satellite or wireless networks or real-time applications. Furthermore, due to packet congestion, end-to-end retransmissions might be preferred. However, in packet networks, if the links are not reliable enough, feedback may hurt more, and as an alternative, link-by-link retransmissions where packets are routed hop-by-hop toward their destinations, and low link-by-link feedback acknowledgment delay can be a better alternative than end-to-end coding with end-to-end acknowledgment.

In the case of wireless networks, the amount of required feedback will be huge to achieve reliability in a retransmission-based scheme. Furthermore, end-to-end retransmissions are not suited for multicast connections because there may be many requests that places an unnecessary load on the network. Packet-level coding is an efficient alternative to feedback-based schemes in wireless networks. This feedforward method is capacity-achieving and resilient against erasures in wireless links, which alleviates the need of a great deal of feedback in unreliable channel conditions. Coding over packets can also provide cooperation gains because nodes that are not transmitting packets can assist the nodes that are. Network coding for cost optimal multicast have been studied. Capacity-achieving packet-level coding schemes for unicast and multicast have been proposed.

Mesh networking aims to provide ubiquitous connectivity and Internet access in urban, suburban, and rural environments, and intelligent transportation systems, with few gateway points, with a flexible deployment. A multi-radio unification protocol for multi-hop networks has been developed to optimize local spectrum usage via intelligent channel selection. Recent studies have shown that WiFi routers are a good alternative to long-distance WiFi links that require high-gain directional antennas and expensive base stations. Using multi-hop paths with stronger links for long backhaul connections may provide better data rates, and possibly be a practical and cost-effective alternative for connectivity. To this end, secure, reliable multi-path routing protocols have been devised and energy-aware routing protocol for multi-hop wireless networks have also been developed. It has been also verified that unlike hierarchical cooperation and distributed multiple-input and multiple-output (MIMO) communication in dense networks, multi-hop can achieve better capacity scaling. Multi-path scheduling has been studied in different contexts. Although a low delay scheduling mechanism for a sliding window protocol has been proposed, coding has been implemented only over one channel. A random linear network coding (RLNC) based simulation scheme for low delay 2-path scheme has been developed, however, the effect of recoding has not been studied.

Although urban areas with high-capacity demands have very high revenue potential, with 60% of global population in rural environments, it is required to explore cheaper alternatives. With the use of low-cost and high-speed WiFi technology, plug-and-play type small cells, flexible and programmable software defined networks, and hardware sharing possibilities of these equipment and functional virtualization, digital divide between urban and rural scenarios can be bridged. Since the main bottleneck in rural areas is connectivity, and the network has to be scalable over large areas and physical links, it makes sense to start from investigating the efficiency of multi-hop line networks in terms of throughput and end-to-end delays. This baseline can pave the way for investigating the performance of lightly congested mesh networks.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

The concepts, systems, and techniques described herein are directed toward adaptive coding and scheduling of packets in wireless networks, such as delay constrained wireless networks. In some embodiments, the adaptive coding and scheduling can be achieved by exploiting the delay sensitivity of the receiver, for example, by adaptively adjusting a coding bucket size based on the sensitivity of the receiver. In some such embodiments, the adaptive coding and scheduling can be achieved by utilizing a discrete water filling (DWF) scheme (technique).

According to one illustrative example embodiment, a computer-implemented method to adaptively code and schedule packets in a wireless network may include determining number of paths between a sender and a receiver in a multipath (MP) network, determining erasure rates for each path of the paths between the sender and the receiver, determining a multipath rate, determining a coding bucket size based on the multipath rate, and determining a multipath delay for the coding bucket size and the erasure rates.

According to one illustrative example embodiment, a computer-implemented method to adaptively code and schedule packets in a wireless network may include determining an erasure rate for each link of a plurality of links between a sender and a receiver in a multihop multipath (MM) network, the MM network including a plurality of hops between the sender and the receiver. The method may also include determining combinations of links through the hops between the sender and the receiver, determining a multihop multipath rate, determining a coding bucket size based on the multihop multipath rate, and determining a multihop multipath delay for the coding bucket size and the erasure rates.

According to one illustrative example embodiment, a system to adaptively code and schedule packets in a wireless network includes one or more non-transitory machine-readable mediums configured to store instructions and one or more processors configured to execute the instructions stored on the one or more non-transitory machine-readable mediums. Execution of the instructions may cause the one or more processors to determine number of paths between a sender and a receiver in a multipath (MP) network, determine erasure rates for each path of the paths between the sender and the receiver, determine a multipath rate, determine a coding bucket size based on the multipath rate, and determine a multipath delay for the coding bucket size and the erasure rates.

According to one illustrative example embodiment, a system to adaptively code and schedule packets in a wireless network includes one or more non-transitory machine-readable mediums configured to store instructions and one or more processors configured to execute the instructions stored on the one or more non-transitory machine-readable mediums. Execution of the instructions may cause the one or more processors to determine an erasure rate for each link of a plurality of links between a sender and a receiver in a multihop multipath (MM) network, the MM network including a plurality of hops between the sender and the receiver. Execution of the instructions may also cause the one or more processors to determine combinations of links through the hops between the sender and the receiver, determine a multihop multipath rate, determine a coding bucket size based on the multihop multipath rate, and determining a multihop multipath delay for the coding bucket size and the erasure rates.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 illustrates an example adaptive coding and scheduling in a multipath (MP) setting, in accordance with an embodiment of the present disclosure.

FIG. 2 illustrates an example operation of a DWF packet scheduler for the multipath (MP) packet allocation of FIG. 1, in accordance with an embodiment of the present disclosure.

FIG. 3 is a flow diagram illustrating an example process to adaptively code and allocate packets in a multipath (MP) setting, in accordance with an embodiment of the present disclosure.

FIG. 4A illustrates an example adaptive coding and scheduling in a multihop multipath (MM) setting with recoding at intermediate nodes, in accordance with an embodiment of the present disclosure.

FIG. 4B illustrates an example adaptive coding and scheduling in a multihop multipath (MM) setting without recoding at intermediate nodes, in accordance with an embodiment of the present disclosure.

FIG. 5 is a flow diagram illustrating an example process to adaptively code and allocate packets in a multihop multipath (MM) setting, in accordance with an embodiment of the present disclosure.

FIG. 6 illustrates selected components of an example computing device that may be used to perform any of the techniques as variously described in the present disclosure, in accordance with an embodiment of the present disclosure.

### DETAILED DESCRIPTION

Techniques are disclosed for adaptive coding and scheduling of packets in wireless networks, such as delay constrained wireless networks. The adaptive coding and scheduling schemes are particularly suited for optimizing the delay cost of the end user in a wireless network. This can be achieved by exploiting the delay sensitivity of the receiver, for example, by adaptively adjusting a coding bucket size based on the sensitivity of the receiver.

In accordance with some embodiments, the adaptive coding and scheduling scheme described herein may be implemented by a multipath (MP) packet scheduler for MP networks. The MP packet scheduler is configured to schedule the sending of packets such that the in-order delivery time across the multiple paths available between consecutive hops is minimized or effectively minimized. The minimization (or effective minimization) of the in-order delivery time across the multiple paths is achieved by utilizing a discrete water filling (DWF) scheme (technique) for balanced allocation of packets across the different multiple paths. In this manner, the MP packet scheduler can leverage the multiple logical or physical paths available in a point-to-point link. Thus, the various embodiments of the adaptive coding and scheduling scheme incorporate coding and DWF schemes to minimize in-order delivery time.

In an embodiment, the adaptive coding and scheduling scheme for MP networks can be applied to multihop (MH) networks. An example of a multihop multipath (MM) network is where, for instance, each link (sometimes referred to as a hop) in the network has one or more different paths. In such embodiments, the adaptive coding and scheduling scheme determines the optimal path allocation from a sender (e.g., transmitting node) to a receiver (e.g., receiving node) that maximizes the rate at the receiver. In the case of recoding (i.e., intermediate nodes recode and forward packets), the maximum rate at the receiver is determined from the water filling rate of the bottleneck link (i.e., the link in the MM network with the lowest water filling rate among all hops). These and other advantages and alternative embodiments will be apparent in light of this disclosure.

The following introductory concepts and terminology are described to facilitate and otherwise assist in understanding the various embodiments of the adaptive coding schemes described in this disclosure. In one example use case, assume that a sender (Tx) and a receiver (Rx) are connected by a point-to-point wireless erasure channel, and the sender wants to transmit a flow f composed of N packets {P₁^{f}, . . . , P_{N}^{f}} to the receiver. Also assume that all data packets are available at the sender prior to any transmission of the packets by the sender. At the sender, a coding bucket is created that functions as a head of the line (HOL) generation. To encode, the sender can sequentially partition the N packets into generations {G₁^{f}, . . . , G_{M}^{f}}, where M is the number of generations. Note that the generation may have different numbers of packets. Given the bucket size at a time slot t, the sender can read the HOL generation Gₕ^{f}={Pₕ_{₁}^{f}, . . . , Pₕ_{_{K}}^{f}}, where h is the generation index and K is the number of packets in the bucket. In an example embodiment, the sender can generate a coded packet P[t] as a linear combination of all packets in Gₕ^{f}, as follows:

P[t]=Σₖ₌₁^{K}αₖ[t]Pₕ_{ₖ}^{f} (1)

where α[t]=(α₁[t], . . . , α_{K1}[t]) is the coding coefficient vector, which is uniformly chosen at random from the space [symbol] _{q}^{K} over some finite field [symbol] _{q}.

The receiver collects (e.g., receives) the coded packets over time. If q is large enough, the receiver can decode the K packets with high probability. The receiver can then send an ACK (e.g., an ACK message) via a feedback link to the sender, which is successfully received by the sender after D time slots. Upon receiving the ACK, the sender moves to a new HOL generation by adjusting K adaptively based on the receiver delay constraints.

In the example use case, the receiver can buffer the packets to ensure in-order final delivery of N packets of flow f. For example, as an illustration, consider a transmission of a bucket of K packets G_{g}^{f}={P_{g}_{₁}^{f}, . . . , P_{g}_{_{K}}^{f}}. Once the receiver obtains K linearly independent coded packets of the bucket, the receiver can decode all K packets together. Upon decoding the K packets, the receiver can send an ACK to the sender, which is always received correctly in D time slots. When informed (e.g., upon receiving the ACK from the receiver), the sender empties the coding bucket and moves Knew packets sequentially into the coding bucket.

In an embodiment, since all packets in G_{g}^{f} are decoded together at the receiver, the final in-order inter-arrival time slot ΔT_{g}_{ⱼ} at the sender satisfies ΔT_{g}_{ⱼ}=T_{g}_{ⱼ}−T_{g}_{ⱼ₋₁}=0 for j=2, . . . , K Here, Tᵢ is the final in-order delivery time slot in which the i^{th} original packet is decoded at the receiver, and T_{g}_{ᵢ} is the final in-order delivery time in which the j^{th} packet in the g^{th} bucket (i.e., the (gK+j)^{th} original data packet) is decoded at the receiver. More specifically, the final in-order inter-arrival time slot ΔT_{g}_{ⱼ} is given by the following relation:

$$Δ {T}_{i} = \{ \begin{matrix}{T}_{{g}_{K}} + D , & if j = 1 , \\ 0 , & if j = \{ 2 , … , K \}\end{matrix} .$$

Assuming a packet erasure probability ∈ of the forward link, the transmission rate of the coded packets is r=1−∈, and the expected time to receive K linearly independent coded packets is K/r. Hence, the average value of ordered interarrival time for the packet in bucket g can be defined by following expectation relation:

$$𝔼 [ Δ {T}_{{g}_{j}} ] = \{ \begin{matrix}\frac{K}{r} + D , & if j = 1 , \\ 0 , & if j = \{ 2 , … , K \}\end{matrix} \qquad ( 2 )$$

where the expectation is taken over the distribution of packet erasures over the system and all the randomness associated with the coding and scheduling scheme.

As an example, consider the case when the packet injection process is a renewal process where a renewal occurs with probability r=1−∈ at time slot t∈{1, 2, . . . }. In this case, the time between the final in-order delivery time slots T_{g}_{ⱼ} for j={1, . . . , K} in coding bucket g={1, . . . , M} are independent and identically distributed (i.i.d) geometrically distributed random variables with success probability r.

In an embodiment, a delay metric is devised to exploit the delay sensitivity of the receiver. In such embodiments, the delay metric can be devised as a function of the in-order delivery time of the flow f. For example, considering the lₚ-norm of the sequence of i.i.d geometric random variables ΔT=(ΔT₁, . . . , ΔT_{N}) (i.e., [symbol] [∥ΔT∥ₚ]), the delay cost function can be defined by the relation:

$$\tilde{d} ( p ) = \frac{1}{L {N}^{\frac{1}{P}}} 𝔼 [ {( {\sum }_{i = 1}^{N} {ΔT}_{i}^{p} )}^{1 / p} ] , p ∈ [ 1 , ∞ ) \qquad ( 3 )$$

where L is the size of each data packet and p models the delay sensitivity of the receiver. It will be appreciated in light of this disclosure that this metric can be determined from the type of applications running on the receiver. For example, if a user is downloading a file, the user (the receiver) may be more concerned about shortening the overall completion time. However, if the user running a real-time application, such as a real-time video application or a real-time gaming application, then the user may be more sensitive to the maximum inter-arrival time between two packets. Applying equation (3), when p=1,

$$\tilde{d} ( 1 ) = \frac{1}{LN} {\sum }_{i = 1}^{N} 𝔼 [ {ΔT}_{i} ] ,$$

which is the average delay per packet, normalized by the total size of the received data L. Hence, minimizing \tilde{d}(1) is equivalent to maximizing the throughput \tilde{d}(1)⁻¹ of the system. When p=∞,

$$\tilde{d} ( ∞ ) = \frac{1}{L} 𝔼 [ {max}_{i = 1 , … , N} Δ {T}_{i} ] ,$$

which is the maximum expected inter-arrival time between any two successive packets or the per-packet delay. Hence, minimizing \tilde{d}(∞) is equivalent to minimizing per-packet delay. Lower and upper bounds for \tilde{d}(∞) can be determined since the value of [symbol] [∥ΔT∥ₚ] is not known for p>1.

In the case of a sequence of i.i.d geometric random variables X=(X₁, . . . , X_{N}), the expected value of [symbol] [∥ΔT∥ₚ] is not known for p>1. In such cases, known bounds (such as lower and upper bounds) can be determined and used to approximate \tilde{d}(p) for p>1. For example, when p=∞,

$$\begin{matrix}\tilde{d} ( ∞ ) = {lim}_{p \to ∞} \frac{1}{L {N}^{\frac{1}{P}}} 𝔼 [ {( {\sum }_{i = 1}^{N} {ΔT}_{i}^{p} )}^{1 / p} ] \\ = \frac{1}{L} {𝔼 [ {max}_{i = 1 , … , N} Δ {T}_{i} ]}_{i} {\geq }^{\overbrace{( a )}} \frac{1}{L} {max}_{i = 1 , … , N} 𝔼 [ Δ {T}_{i} ]\end{matrix} \qquad ( 4 )$$

where (a) is due to the Jensen's inequality.

In an embodiment, a bounding technique to approximate d̅(p) assumes a case where the feedback delay is zero and the generation size K is identical for all buckets. In such cases, the inter-arrival times ΔT₁₁, j={1, . . . , K} of the original packets in the i^{th} bucket are i.i.d geometrically distributed random variables with success probability r. The sum of K i.i.d variables ΔTᵢᵢ for coding bucket i={1, . . . , └N/K┐}, which is a negative Binomial random variable, can be defined by the relation:

Sᵢ(K,r)=Σⱼ₌₁^{K}ΔTᵢ_{ⱼ},i=1, . . . ,┌N/K┐ (5)

In the case where

$$\hat{S} = {max}_{i = 1 , … , ⌈ N / K ⌉} {S}_{i} ( K , r )$$

is the maximum delay among all buckets and S(K,r) has the same distribution as Sᵢ(K,r), the average delay per coding bucket is

$$𝔼 [ S ( K , r ) ] = 𝔼 [ {S}_{i} ( K , r ) ] = \frac{K}{R}$$

for each i, and [symbol] [Ŝ] is the average value for the maximum of these delays. From convexity of the maximum function, the lower bound for [symbol] [Ŝ] can be defined by the relation:

$$𝔼 [ \hat{S} ] \geq {max}_{i = 1 , … , ⌈ N / K ⌉} \{ 𝔼 [ {S}_{i} ( K , r ) ] \} = K / r \qquad ( 6 )$$

Applying Holder's inequality, an upper bound on [symbol] [Ŝ] for approximating \tilde{d}(p) can be defined by the relation:

$$𝔼 [ \hat{S} ] \overbrace{\leq }^{( a )} 𝔼 [ {( {\sum }_{i = 1}^{⌈ N / K ⌉} {{S}_{i} ( K , r )}^{m} )}^{1 / m} ] \overbrace{\leq }^{( b )} {( {\sum }_{i = 1}^{⌈ N / K ⌉} 𝔼 [ {{S}_{i} ( K , r )}^{m} ] )}^{1 / m} \qquad ( 7 )$$

where (a) is due to letting x=max_{i=1, . . . N}xᵢ, which results in [symbol] [∥x∥_{∞}]≤ [symbol] [(Σᵢ₌₁^{N}xᵢ^{m})^{1/m}] because ∥x∥ₚ when 0<m<p and xᵢ>0; and (b) follows from f(X)=X^{1/m} being concave when q>1 and X>0. Hence, applying Jensen's inequality, [symbol] [f(X)]<f( [symbol] [X]), and inserting X=Σᵢ₌₁^{N}Sᵢ(K,r)^{m} into f(X)=X^{1/m}, f(X)=(Σᵢ₌₁^{N}Sᵢ(K,r)^{m})^{1/m}. Applying relation (7), an upper bound on \tilde{d}(∞) can be defined by the relation.

$$\tilde{d} ( ∞ ) = \frac{1}{L} 𝔼 [ {max}_{i = 1 , … , N} Δ {T}_{i} ] \leq \frac{1}{L} 𝔼 [ {( {\sum }_{i = 1}^{N} Δ {T}_{i}^{m} )}^{1 / m} ] \leq \frac{1}{L} {( {\sum }_{i = 1}^{N} 𝔼 [ Δ {T}_{i}^{m} ] )}^{1 / m} \qquad ( 8 )$$

Note that if X is geometrically distributed with parameter r, its moments satisfy the condition

$$𝔼 [ {X}^{m} ] \leq \frac{m !}{{( log ( 1 / ( 1 - r ) ) )}^{m}}$$

for m∈ [symbol] . Thus, applying relation (8), the upper bound \tilde{d}(∞) can be defined by the relation:

$$\tilde{d} ( ∞ ) \leq \frac{{( N m ! )}^{1 / m}}{L log ( 1 / ( 1 - r ) )} , m ϵ ℕ \qquad ( 9 )$$

It will be appreciated that, unlike relation (8), upper bound relation (9) can be readily computed for m>2.

Consider an example case where the delay cost function is defined by the relation:

$$d ( p ) = \frac{1}{L} {( \frac{1}{N} {\sum }_{i = 1}^{N} {( 𝔼 [ Δ {T}_{i} ] )}^{p} )}^{1 / p} , p ϵ [ 1 , ∞ ) \qquad ( 10 )$$

In delay cost function (10), when p=1,

$$d ( 1 ) = \frac{1}{L N} {\sum }_{i = 1}^{N} 𝔼 [ Δ {T}_{i} ] ,$$

which is the average delay per packet \tilde{d}(1). When p=∞,

$$d ( ∞ ) = \frac{1}{L} 𝔼 [ {max}_{i = 1 , … , N} Δ {T}_{i} ] ,$$

which is indeed a lower bound to the per packet delay \tilde{d}(∞) that is due to Jensen's inequality as explained above. Using d(1) and applying relation (10), the bucket size K can be defined by the relation:

$$K = \frac{Dr}{rLd ( 1 ) - 1} \qquad ( 11 )$$

If the adaptive coding scheme selects or otherwise determines a bucket size of K for a flow of N packets, the delay cost in relation (10) can be simplified as:

$$d ( p ) = \frac{1}{L} {( \frac{\frac{N}{K} {\sum }_{j = 1}^{K} {( 𝔼 [ Δ {T}_{{t}_{j}} ] )}^{p}}{N} )}^{1 / p} = \frac{\frac{K}{r} + D}{L {K}^{1 / p}} \qquad ( 12 )$$

where K is assumed to be in the region [1, Kₘₐₓ], where Kₘₐₓ is the maximum bucket size. Note that the limiting assumption is justifiable through the maximum computation complexity that can be handled by the target system. Applying relations (11) and (12), the trade-off between d(1) and d(∞) can be defined by the relation:

$$d ( ∞ ) = \frac{D}{L - \frac{1}{d ( 1 ) r}} \qquad ( 13 )$$

The optimal block size K⁺ that minimizes d(p) for a point-to-point link model can be defined by the relation:

$${K}^{*} = ( \frac{rD}{p - 1} ) {\vert}_{[ 1 , {K}_{max} ]} , 0 < ϵ < 1 \qquad ( 14 )$$

where (x)_{[a,b]} [symbol] min(max(a, x), b).

Note that the tail probability for the delay per bucket satisfies [symbol] [S(K,r)>lK/r]≤exp(−(1−1/l)²lK/2), where l≥1. This implies that, when the bucket size K is large enough, S(K,r) concentrates well around its mean. It follows then and using the independence of the bucket delays, the maximum delay among all buckets Ŝ satisfies the relation [symbol] [Ŝ>lK/r]≤1−(1−exp(−(1−1/l)² lK/2))^{┌N/K┐}, where l≥1. Similar to S(K,r), Ŝ concentrates around its mean by choosing a bucket size Kthat is sufficiently large.

### Adaptive Coding and Scheduling in a Multipath (MP) Setting

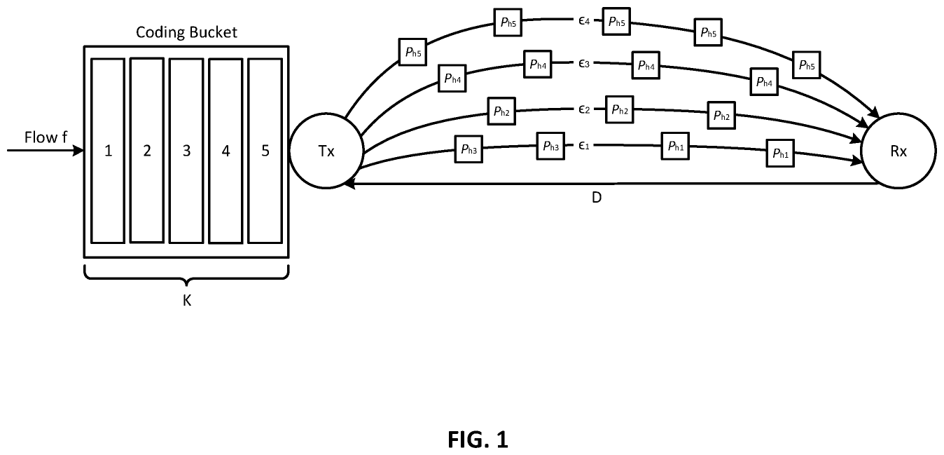

FIG. 1 illustrates an example adaptive coding and scheduling in a multipath (MP) setting, in accordance with an embodiment of the present disclosure. As can be seen, the illustrated example is of a MP point-to-point network between a sender node (Tx) and a receiver node (Rx). In particular, a generation of five packets (K=5) in the coding bucket sent by the sender to the receiver over this link are transmitted over four paths, where each path is modeled as an erasure channel having distinct packet erasure rates ∈₁, ∈₂, ∈₃, ∈₄. Upon successfully receiving and decoding the generation of five packets transmitted by the sender, the receiver sends an ACK via a feedback link to the sender. For clarity, the feedback link is assumed to be noiseless in that any noise that may be present on the link is negligible because of the cumulative feedback. Note also that the feedback is not erased, and is received by the sender in D time units (i.e., within D feedback delay). As previously explained, the receiver decodes the packets in the generation together (e.g., the five packets in the generation are decoded together). Upon receiving the ACK, the sender empties the coding bucket (e.g., removes the five packets currently in the coding bucket) and moves new packets sequentially into the coding bucket.

In such embodiments, to transmit the generation of five packets (e.g., the packets in the coding bucket) to the receiver, the sender distributes the packets to the four paths such that the delay until a successful reception of the generation by the receiver is minimized. To this end, in an embodiment, the sender utilizes a DWF optimization scheme to determine the scheduling of the packets in the coding bucket over the available paths to minimize the overall delay over the four paths. The DWF optimization problem provides a solution that defines one possible realization of the allocation of the packets over the available paths. In the illustrative example, as can be seen in FIG. 1, the DWF scheme may have provided a realization whereby the sender transmits packets 1 and 3 (i.e., Pₕ_{₁} and Pₕ_{₃}) over the path having erasure rate ∈₁, packet 2 (i.e., Pₕ_{₂}) over the path having erasure rate ∈₂, packet 4 (i.e., Pₕ_{₄}) over the path having erasure rate ∈₃, and packet 5 (i.e., Pₕ_{₅}) over the path having erasure rate ∈₄. Note that, as can be seen, the sender can transmit a packet multiple times over the same path based on, for example, the erasure rate of the path to ensure successful reception of the packet by the receiver. Also note that each transmitted packet may be a coded packet (e.g., a linear combination of the packets in the generation). Further note that the coded packets may be the same or a different linear combination of the packets in the generation.

In a more general sense, in a MP setting, the packets over a point-to-point link between a sender and a receiver are transmitted over Z≥1 paths defined in the set Z={ζ₁, . . . , ζ_{Z}}. A generation Gₕ^{f}={Pₕ_{₁}^{f}, . . . , Pₕ_{_{K}}^{f}} of K packets (e.g., K packets in a coding bucket) can be transmitted over the Z paths. Each path is modeled as a packet erasure channel having different packet erasure rates ∈_{L} as defined in ∈=[∈₁, . . . , ∈_{Z}]^{T}. Here, a K×Z matrix E=(E_{i,j}) can define random variables, where E_{i,j}˜Geo(1−∈ⱼ) specifies the number of transmissions needed to successfully transmit packet kᵢ to the receiver over path ζⱼ. In an embodiment, the packet transmissions on the different paths are concurrent and independent, wherein E_{i,j}⊥E_{k,l}∀i,j,k,l:i≠k,j≠l. The delivery time Bⱼ of the allocated packets over an individual path ζⱼ is a sum of geometric random variables Bⱼ=Σᵢ₌₁^{K}a_{i,j}E_{i,j}. Here, A=(a_{i,j}) is a K×Z binary matrix of packet allocations over the different paths. Note that, as E_{i,j}˜Geo(1−∈ⱼ)∀i, Bⱼ has a negative binomial distribution. In embodiments, an objective of the adaptive coding and scheduling scheme disclosed herein is to distribute the packets Pₕ^{f} to the different paths ζⱼ such that the delivery time until a successful reception of a generation is minimized. Note that the path having the maximum total transmissions for its scheduled packets (i.e., the slowest path) determines the delay. That is, the slowest path determines the final in-order MP delivery time Tₘₚ of the packets within the scheduled generation. To this end, in an embodiment, the scheduling of the packets in the generation is done in a manner as to minimize Tₘₚ.

Note that the total number of scheduled packets on path ζⱼ is kⱼ=Σᵢ₌₁^{K}a_{i,j}. As K packets in a generation (e.g., K packets in a coding bucket) are scheduled, it follows that Σⱼ₌₁^{Z}kⱼ=K, and the scheduling of the K packets can be defined by the following min-max integer optimization problem:

$$MinDelay \text{:} \begin{matrix}arg min \\ A\end{matrix} 𝔼 [ max ( {B}_{1} , … , {B}_{Z} ) ] \\ s . t . {\sum }_{j = 1}^{Z} {a}_{i , j} = 1 ∀ J ∈ \{ 1 , … , K \} \\ A ∈ {\{ 0 , 1 \}}^{K \times Z} \qquad ( 15 )$$

which is a nonlinear optimization problem with 0-1 integer variables and linear constraints. It will be appreciated that this class of problems has been shown to be NP-complete. Hence, there is no known efficient method to solve min-max integer optimization problem (15). Accordingly, the adaptive coding and scheduling scheme disclosed herein uses an approximation for the objective of the MinDelay problem (min-max integer optimization problem (15)).

In an embodiment, Jensen's inequality is applied to min-max integer optimization problem (15) to obtain a closed form lower bound of objection function as follows:

max( [symbol] [B₁], . . . , [symbol] [B_{Z}])≤ [symbol] [max(B₁, . . . ,B_{Z})] (16)

where the average delivery time over path j∈{1, . . . , Z} is

$$𝔼 [ {B}_{j} ] = {\sum }_{i = 1}^{K} {a}_{i , j} 𝔼 [ {E}_{i , j} ] = {\sum }_{i = 1}^{K} {a}_{i , j} \frac{1}{1 - {ϵ}_{j}} = {k}_{j} \frac{1}{1 - {ϵ}_{j}} .$$

The closed form relation (16) can be applied to the MinDelay optimization problem (15) to generate a discrete water filling (DWF) problem as follows:

$$DWF \text{:} \begin{matrix}arg min \\ K\end{matrix} {max}_{j = 1 , … , Z} ( {k}_{j} \frac{1}{1 - {ϵ}_{j}} ) \\ s . t . {\sum }_{j = 1}^{Z} {k}_{j} = K \\ K ∈ {ℕ}_{\geq 0}^{Z \times 1} \qquad ( 17 )$$

where K=[k₁, . . . , k_{Z}]^{T}. In the DWF formulation (17), the packet allocation balances the total number of transmissions required per path. That is, the packet allocation balances the filling of different paths to achieve an equalized number of transmissions among all paths. Note that, implicitly, the delay of the delay maximizing path is minimized.

Note that, for a given E and bucket size K, a DWF packet scheduler can compute the number of packets allocated for each path, given by K and the MP delivery time

$${T}_{mp} ( K , ϵ ) = {max}_{j = 1 , … , Z} 𝔼 [ {B}_{j} ] ,$$

and Tₘₚ^{*} is the optimal solution of DWF formulation (17). Stated differently, for a given E and bucket size K, the DWF packet scheduler can compute the number of packets allocated for each path, given by K and the MP delay

$${d}_{mp} ( K , ϵ ) = {max}_{j = 1 , … , Z} ( {k}_{j} \frac{1}{1 - {ϵ}_{j}} ) ,$$

and dₘₚ^{*} is the optimal solution of the DWF formulation (17).

The MP receiver rate rₘₚ can be defined by the relation

$${r}_{m p} = \frac{K}{{T}_{m p}^{*}} ,$$

and the theoretical DWF MP capacity Cₘₚ can be defined by the relation Cₘₚ=Z−Σᵢ₌₁^{Z}∈ᵢ. Note that the optimization of DWF formulation (17) can be solved efficiently (the maximum K for a given delay dₘₚ can be defined by the relation K=Σⱼ₌₁^{Z}kⱼ, where kⱼ=└(1−∈ⱼ)Tₘₚ┘, ∀j∈{1, . . . , Z}). Hence, the optimal delivery time for a given K can be found through a search on the interval

$$[ 0 , \frac{K}{1 - {max}_{i ∈ \{ 1 , … , Z \}} ( {ϵ}_{j} )} ] .$$

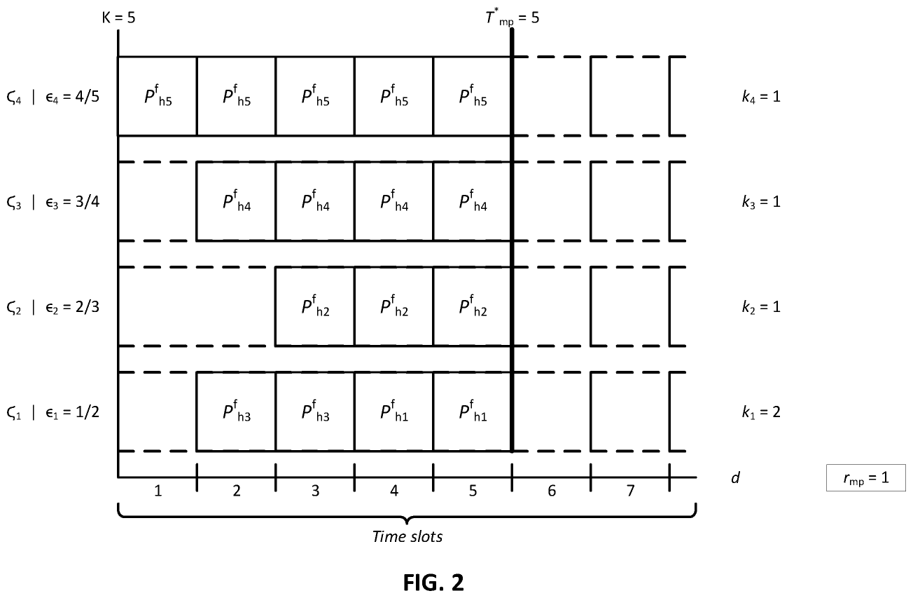

FIG. 2 illustrates an example operation of a DWF packet scheduler for the multipath (MP) packet allocation of FIG. 1, in accordance with an embodiment of the present disclosure. The example illustration in FIG. 2 is one solution (realization) of the DWF formulation (17). In particular, FIG. 2 illustrates the mechanism of the DWF packet scheduler for a point-to-point link with Z=4 paths. The DWF scheduler determines the number of packets to schedule per path and the average number of transmission slots from or otherwise based on a solution of the DWF formulation (17).

In more detail, as can be seen in FIG. 2, path ζ₁ has the indicated erasure probability ∈₁=½ (which implies a success probability or transmission rate of r₁=½), path ζ₂ has the indicated erasure probability ∈₂=⅔ (which implies a success probability or transmission rate of r₂=⅓), path ζ₃ has the indicated erasure probability ∈₃=¾ (which implies a success probability or transmission rate of r₃=¼), and path ζ₄ has the indicated characteristic erasure probability ∈₄=⅘ (which implies a success probability or transmission rate of r₄=⅕). Based on the respective erasure probabilities (∈₁, ∈₂, ∈₃, ∈₄) of the four paths (Z=4) and the coding bucket size (K=5), the solution of the DWF formulation (17) specifies an optimal distribution of the five packets in flow f over the four paths. In the illustrated example of FIG. 2, the optimization specifies the following scheduling of the transmission of the five packet: packets Pₕ_{₁}^{f} and Pₕ_{₃}^{f} to be transmitted over path ζ₁, packet Pₕ_{₂}^{f} to be transmitted over path ζ₂, packet Pₕ_{₄}^{f} to be transmitted over path ζ₃, and packet Pₕ_{₅}^{f} to be transmitted over path ζ₄.

Still referring to the illustrative example of FIG. 2, as can be seen, the x-axis denotes the delay d in units of time slots. Based on the respective erasure rates of the paths, DWF packet scheduler codes packet Pₕ_{₁}^{f} and transmits coded packet Pₕ_{₁}^{f} two times over path ζ₁ to ensure reception by the receiver. DWF packet scheduler also codes packet Pₕ_{₃}^{f} and transmits coded packet Pₕ_{₃}^{f} two times over path ζ₁ to ensure reception by the receiver. For example, as can be seen in FIG. 2, DWF packet scheduler transmits coded packet Pₕ_{₁}^{f} twice, once at time slot 5 and again at time slot 4, and also transmits coded packet Pₕ_{₃}^{f} twice, once at time slot 3 and again at time slot 2. In like manner, DWF packet scheduler transmits coded packet Pₕ_{₂}^{f} three times (once at time slot 5, once at time slot 4, and again at time slot 3), transmits coded packet Pₕ_{₄}^{f} four times (once at time slot 5, once at time slot 4, once at time slot 3, and again at time slot 2), and transmits coded packet Pₕ_{₅}^{f} five times (once at time slot 5, once at time slot 4, once at time slot 3, once at time slot 2, and again at time slot 1). It will be appreciated in light of this disclosure that the solution of the DWF formulation (17) does not specify a distribution of packets over the paths that exceeds the coding bucket size K.

Note that the solution of the DWF formulation (17) does not explicitly impose a packet delivery order. Also note that, despite the logical sequential packet scheduling as suggested by the Pₕ_{ᵢ}^{f}, i∈{1, . . . , K} indications in FIG. 2, the in-order delivery of the packets cannot be guaranteed due to actual channel realizations and lack of perfect synchronization, for example. By applying the adaptive coding and scheduling scheme (i.e., coding the K packets and distributing the packets accordingly as specified by the solution of the DWF formulation (17)), the DWF packet scheduler incorporates forward error correction where the receiver acknowledges degrees of freedom of the current generation. Also note that the transmitted coded packets Pₕ_{ᵢ}^{f}, i∈{1, . . . , K} may be the same or a different linear combination of the packets (K=5) of the transmitted generation.

For delay constrained MP scheduling, since Tₘₚ defines the final in-order delivery of the K coded packets, the rate r in expectation relation (2) above can be substituted with rₘₚ, which results in the delay cost function

$$d ( p ) = \frac{1}{{LK}^{\frac{1}{p}}} ( \frac{K}{{r}_{m p}} + D ) .$$

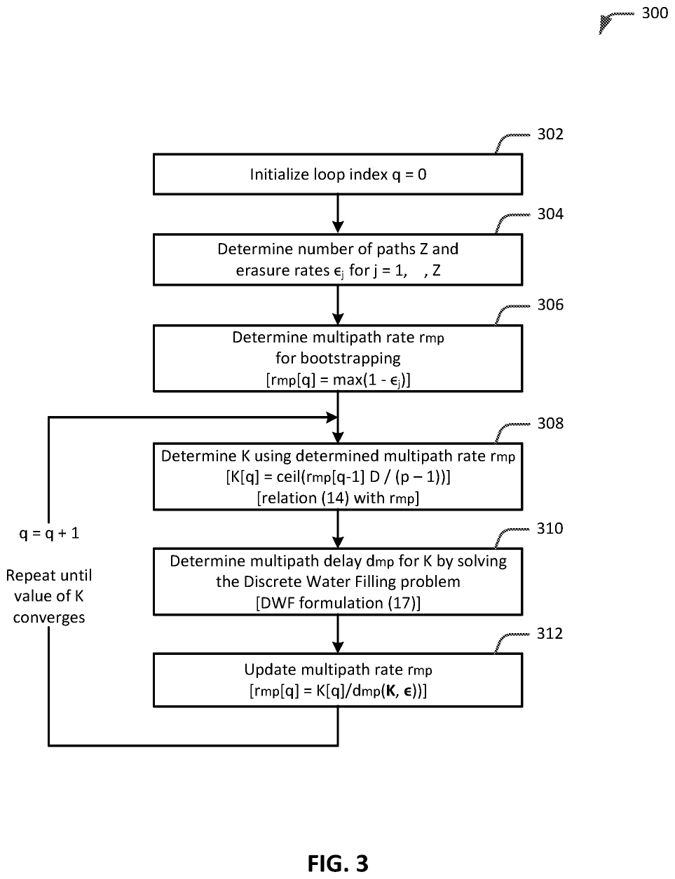

FIG. 3 is a flow diagram illustrating an example process 300 to adaptively code and allocate packets in a multipath (MP) setting, in accordance with an embodiment of the present disclosure. The operations, functions, or actions illustrated in example process 300 may in some embodiments be performed by an MP packet scheduler to implement adaptive coding and scheduling based on a DWF scheme. The operations, functions, or actions described in the respective blocks of example process 300 may also be stored as computer-executable instructions in a non-transitory computer-readable medium, such as a memory 608 and/or a data storage 610 of a computing device 600, which will be further discussed below. In some instances, process 300 may be implemented as program instructions 612 and executed by components of computing device 600.

As will be further appreciated in light of this disclosure, for this and other processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In brief, example process 300 implements an iterative approach to optimize the delay cost defined by relation (12) with the multipath DWF formulation defined by relation (17). In process 300, the optimal coding bucket size K is increased during the first iterations. This is because the process is initialized with the best single path solution. Using all available Z paths to transmit K packets can lead to a rate increase. For instance, a higher rate implies that more packets are transmitted under the same delay constraint. Hence, the optimal coding bucket size K for a given sensitivity pincreases. Once all paths are leveraged, the minimum delay for the given sensitivity pgrows proportionally with K. However, the rate remains approximately the same as all paths are optimally leveraged in the water filling sense.

With reference to example process 300 of FIG. 3, at operation 302, a loop index (q) is initialized. The loop index maintains a count of the iterations through process 300 and, in particular, operations 308 through 312, which optimize the size of the coding bucket (K) with respect to a delay sensitivity p. For example, in some implementations, the value of K (the size of the coding bucket) can be iteratively optimized and the DWF formulation (17) solved at each iteration to obtain an optimal distribution for each determined value of K. It will be appreciated in light of this disclosure that, in the case of a single path, the iterations are not needed (e.g., not performed).

At operation 304, the number of paths (Z) and corresponding erasure rates for each path (∈ⱼ for j={1, . . . , Z}) are determined. The number of paths and the corresponding erasure rates for each path are used in determining the multipath rate for the MP network.

At operation 306, a multipath rate (rₘₚ) is determined to bootstrap the process. The multipath rate rₘₚ can be determined to be a lower bound to the multipath rate assuming that all the packets in the coding bucket are transmitted using the worst path with the highest erasure rate ∈ⱼ. In one example implementation, the multipath rate rₘₚ can be the best single path rate. Note that the multipath rate rₘₚ determined at operation 306 is used one time as an initial rate to determine a coding bucket size.

At operation 308, a coding bucket size (K) is determined. The size of the coding bucket K can be determined using relation (14) with the multipath rate rₘₚ.

At operation 310, the multipath delay (dₘₚ) for the current coding bucket size (K) is determined. The multipath delay dₘₚ can be determined by solving the DWF formulation (17). The solution to the DWF formulation (17) specifies a packet allocation over the available paths that minimizes the multipath delay dₘₚ for the given erasure probabilities and coding bucket size K. That is, for a current coding bucket size K and multipath rate rₘₚ, the solution of the DWF formulation (17) specifies an optimal distribution of the packets over the available paths that maximizes the multipath rate rₘₚ.

At operation 312, the multipath rate rₘₚ is updated. The multipath rate rₘₚ can be updated based on the current coding bucket size K and the multipath delay dₘₚ. The DWF formulation (17) provides an updated multipath delay dₘₚ for the bucket size K. For example, in some implementations, the multipath delay dₘₚ can be updated according to the current bucket size K/erasure rates. Also, in some cases, the bucket size K can be updated according to a given multipath delay dₘₚ/a specified delay requirement. The updated multipath rate rₘₚ can then be used to determine an updated coding bucket size K in the next iteration of process 300.

In some embodiments, operations 308-312 can be repeated to optimize the coding bucket size K and to determine an optimal allocation of packets over the available paths for a current coding bucket size K at each iteration. In such embodiments, operations 308-312 can be iterated until the value of K (the size of the coding bucket) converges, which is an indication of the minimization of the worst-case end-to-end delay for a given delay sensitivity p.

### Adaptive Coding and Scheduling in a Multihop Multipath (MM) Setting

In general, a multihop (MH) network can be composed of H links in tandem, and H+1 nodes h, wherein node 0≤h≤H−1 is connected to node H+1^{th} through the erasure link. Here, node 0 denotes the sender (Tx) and node H denotes the receiver (Rx). The probability of transmission failure (i.e., the erasure rate) on link h is ∈ₕ.

In one example use case, assume that the erasure rate of each link is independent of the other links. Also assume that the average delay per hop is D̅= [symbol] [D]. In this example case, given the number of hops H, and the delay per hop D(h), h∈{1, . . . , H}, the total delay of the feedback D_{H} can be defined by the relation D_{H}=Σₕ₌₁^{H}D(h), and its average value D̅_{H} can be defined by the relation D̅_{H}= [symbol] [D_{H}]=D̅H. The bucket size for each transmitter node h, h∈{1, . . . , H−1} is assumed to be the same and is denoted by K. Note that MH networks can have different coded transmission and acknowledgement schemes.

In an MH recoded scheme with end-to-end ACK, the sender codes and each intermediate node recodes and forwards. Since the sender codes and each intermediate node recodes, applying the max-flow min-cut theorem, the rate at which the coded packets is transmitted r_{c}^{e2e} can be defined by

$${r}_{c}^{e 2 e} = {min}_{1 , … , H} ( 1 - {ϵ}_{h} ) .$$

The value of d(p) for the MH recoded scheme with end-to-end ACK can be defined by the relation:

$$d ( p ) = \frac{1}{L {K}^{1 / p}} ( \frac{K}{{r}_{c}^{e 2 e}} + {\overline{D}}_{H} ) \qquad ( 18 )$$

Applying the bucket size relation (11) above, the bucket size for the MH recoded scheme with end-to-end ACK can be defined by the relation:

$$K = {{\overline{D}}_{H} ( L d ( 1 ) - \frac{1}{{r}_{c}^{e 2 e}} )}^{- 1} \qquad ( 19 )$$

Applying relations (18) and (19), the maximum per-packet delay for the MH recoded scheme with end-to-end ACK can be defined by the relation:

$$d ( ∞ ) = \frac{{\overline{D}}_{H}}{L - \frac{1}{d ( 1 ) {r}_{c}^{e 2 e}}} \qquad ( 20 )$$

Note that the maximum per-packet delay for the MH recoded scheme with end-to-end ACK scales with the number of hops, and the tradeoff between d(∞) and d(1) is sharper than the tradeoff in the point-to-point case given by relation (13) above.

In an MH recoded scheme with link-by-link ACK, the sender codes and the intermediate nodes recode and forward. Since the sender codes and the intermediate nodes recode, the rate r_{c}¹²¹ at the receiver can be defined by the relation

$${r}_{c}^{\vert 2 \vert} = {min}_{h = 1 , … , H} ( 1 - {ϵ}_{h} ) .$$

Note that in the MH recoded scheme with link-by-link ACK. The ACK from each hop to the previous hop is always received correctly after D time slots. The total average delay of the feedback is the same as the delay for the MH recoded scheme with end-to-end ACK. Thus, the value of d(p) for the MH recoded scheme with link-by-link ACK can be computed using relation (18) above.

In an MH end-to-end coded scheme with end-to-end ACK, the sender codes and no recoding is performed at the intermediate nodes. Therefore, the links can be treated independently of each other. Such an MH network may be considered as a point-to-point link with an effective rate of r^{e2e}=Πₕ₌₁^{H}(1−∈ₕ), which is bounded above by the cut-set bound. Hence, the MH end-to-end coded scheme with end-to-end ACK may not achieve the capacity.

Applying the bucket size relation (11) above, the bucket size for the MH end-to-end coded scheme with end-to-end ACK can be defined by the relation:

$$K = {{\overline{D}}_{H} ( L d ( 1 ) - \frac{1}{{r}^{e 2 e}} )}^{- 1} \qquad ( 21 )$$

Given the total delay of the feedback D_{H}, and exploiting the tradeoff between d(1) and d(∞) in the point-to-point case given by relation (13) above, the maximum per-packet delay for the MH end-to-end coded scheme with end-to-end ACK can be defined by the relation:

$$d ( ∞ ) = \frac{{\overline{D}}_{H}}{L - \frac{1}{d ( 1 ) {r}^{e 2 e}}} \qquad ( 22 )$$

A comparison of the maximum per-packet delay for the MH end-to-end coded scheme with end-to-end ACK (relation (22)) with the maximum per-packet delay for the MH recoded scheme with end-to-end ACK (relation (20)) shows that the effective rate is relatively smaller (and even much smaller) for the MH end-to-end coded scheme. As a result, the tradeoff between d(∞) and d(1) is sharper for the end-to-end coded model.

In accordance with some embodiments disclosed herein, the DWF scheme for MP networks disclosed herein is applied to MH networks to provide a DWF scheme for multihop multipath (MM) networks. In one such example embodiment, a H-hop MM network, where each link has Z different paths, can be considered. In this example case, the packet loss probabilities can be represented in a H×Z matrix ∈. In the matrix, each row represents a link with the corresponding paths represented by the columns. The link-to-link MP rate at the receiver can be defined by the relation:

$${r}_{m p}^{\vert 2 \vert} = {min}_{h ∈ \{ 1 , 2 , … , H \}} {r}_{m p}^{h} \qquad ( 23 )$$

where rₘₚ^{h} is the water filling MP rate for link h. The end-to-end MP rate can be defined as rₘₚ^{e2e}. In the MM DWF scheme, the Z paths over the H links are selected over all combinatorial possibilities such that the water filling MP rate rₘₚ^{e2e} is maximized.

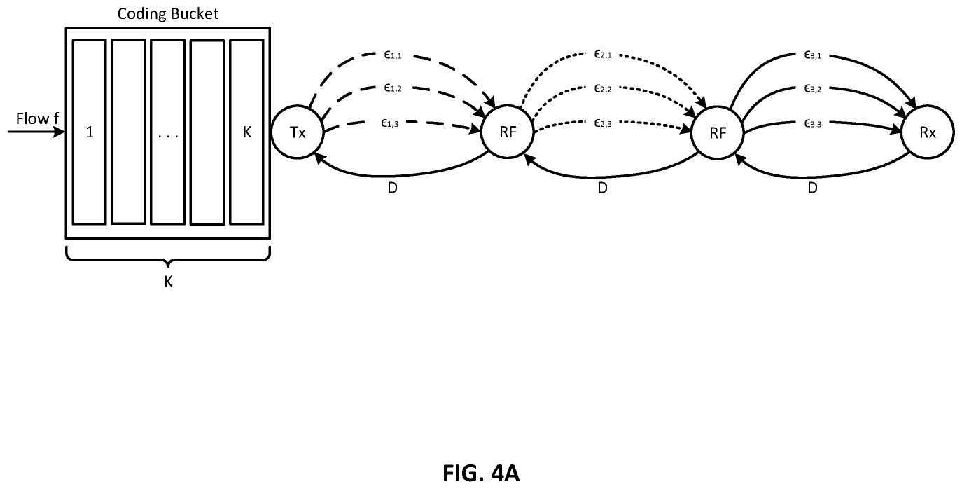

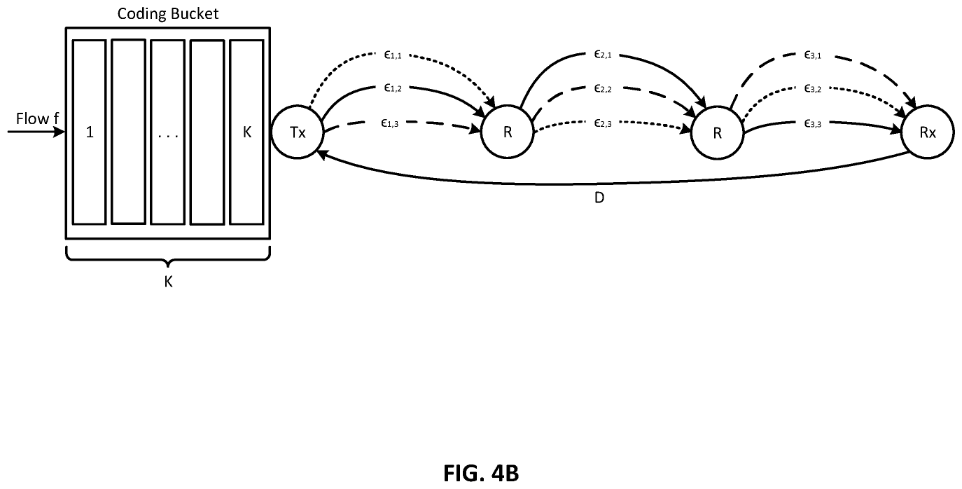

By way of an example, consider a MM network with three hops where each link has three different paths, as illustrated in FIGS. 4A and 4B. In this example, example packet loss probabilities can be as follows:

$$ϵ = [ \begin{matrix}0.1 & 0.3 & 0.6 \\ 0.6 & 0.8 & 0.6 \\ 0.4 & 0.2 & 0.5\end{matrix} ] \qquad ( 24 )$$

In the end-to-end coded scheme (e.g., MM end-to-end coded scheme), for a given K, the DWF scheme provides a solution that maximizes the rate at the receiver (Rx). That is, the DWF solution specifies an optimal path allocation from the sender (Tx) to the receiver (Rx) that maximizes the rate at the receiver (Rx). In the recoded scheme (e.g., MM recoded scheme), the water filling rate of the bottleneck link (i.e., the link with the lowest water filling rate among all hops), determines the maximum rate.

As shown in FIG. 4A, in the illustrated example of the recoded scheme, each line style (solid line, fine dashed line, and course dashed line) visualizes a water filling solution for each hop (e.g., the path with ∈_{1,1}, ∈_{1,2}, ∈_{1,2}, ∈_{1,3}) The DWF formulation specifies an optimal distribution of the packets in K over each link such that the water filling rate of the bottleneck link is maximized.

As shown in FIG. 4B, in the illustrated example of the end-to-end coded scheme, based on the packet loss probabilities and K, a first possible path (first possible end-to-end combination) over the three hops is the sequence of links having packet loss probabilities ∈_{1,1}, ∈_{2,3}, ∈_{3,2} (as visualized by the fine dashed lines), a second possible path (second possible end-to-end combination) over the three hops is the sequence of links having packet loss probabilities ∈_{1,2}, ∈_{2,1}, ∈_{3,3} (as visualized by the solid lines), and a third possible path (third possible end-to-end combination) over the three hops is the sequence of links having packet loss probabilities ∈_{1,3}, ∈_{2,3}, ∈_{3,1} (as visualized by the course dashed lines). The solution of the DWF formulation specifies an optimal distribution of the packets in K over the first, second, and third paths that maximizes the rate at the receiver (Rx).

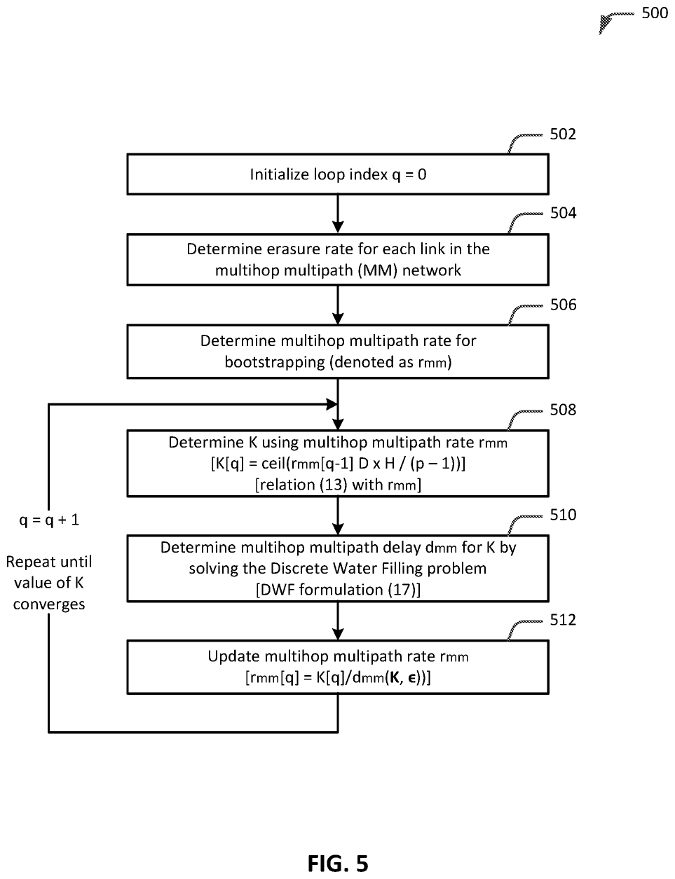

FIG. 5 is a flow diagram illustrating an example process 500 to adaptively code and allocate packets in a multihop multipath (MM) setting, in accordance with an embodiment of the present disclosure. The operations, functions, or actions illustrated in example process 500 may in some embodiments be performed by a packet scheduler for MM to implement adaptive coding and scheduling based on a DWF scheme. The operations, functions, or actions described in the respective blocks of example process 500 may also be stored as computer-executable instructions in a non-transitory computer-readable medium, such as memory 608 and/or data storage 610 of computing device 600, which will be further discussed below. In some instances, process 500 may be implemented as program instructions 612 and executed by components of computing device 600.

With reference to example process 500 of FIG. 5, at operation 502, a loop index (q) is initialized. The loop index maintains a count of the iterations through process 500 and, in particular, operations 508 through 512, which optimize the size of the coding bucket (K). For example, in some implementations, the value of K (the size of the coding bucket) can be iteratively optimized and the DWF formulation (17) solved at each iteration to obtain an optimal distribution for each determined value of K.

At operation 504, the erasure rates for each link in the multihop multipath (MM) network is determined. As will be appreciated in light of this disclosure, the MM network may be an end-to-end MM network or a link-by-link MM network.

At operation 506, a multihop multipath rate (rₘₘ) is determined to bootstrap the process. For example, in the case of an end-to-end MM network, the multihop multipath rate rₘₘ can be defined using the best single path end-to-end solution. In the case of a link-to-link MM network, the multihop multipath rate rₘₘ can be defined using the best single path link-to-link solution. Note that the multihop multipath rate rₘₘ determined at operation 506 is used one time as an initial rate to determine a coding bucket size.

At operation 508, a coding bucket size (K) is determined. The size of the coding bucket K can be determined using relation (14) with the multihop multipath rate rₘₘ.

At operation 510, the multihop multipath delay (dₘₘ) for the current coding bucket size (K) is determined. The multi multipath delay dₘₘ can be determined by solving the DWF formulation (17). For example, in the case of end-to-end MM network, the end-to-end MP rate can be defined as rₘₚ^{e2e}. In the MM DWF scheme, the Z paths over the H links are selected over all combinatorial possibilities such that the water filling MP rate rₘₚ^{e2e} is maximized. In other words, the rate for the best DWF solution of all possible path combinations is used. In the case of recoded and link-to-link MM network, the link-to-link MP rate at the receiver can be defined using relation (23). That is, a local DWF solution is computed or otherwise determined at each hop in the MM network. The maximized rate (or the minimized MM delay—the problems are equivalent) specifies an optimal path allocation of the packets from the sender (Tx) to the receiver (Rx) that maximizes the rate at the receiver (Rx) for the given erasure probabilities and coding bucket size K (i.e., the current coding bucket size K).

At operation 512, the multihop multipath rate rₘₘ is updated. The multihop multipath rate rₘₘ can be updated based on the current coding bucket size K and the multihop multipath delay dₘₘ. The updated multihop multipath rate rₘₘ can then be used to determine an updated coding bucket size K in the next iteration of process 500.

In some embodiments, operations 508-512 can be repeated to optimize the coding bucket size K and to determine an optimal allocation of packets from the sender to the receiver for a current coding bucket size K at each iteration. In such embodiments, operations 508-512 can be iterated until the value of K (the size of the coding bucket) converges, which is an indication of the minimization of the worst-case delay.

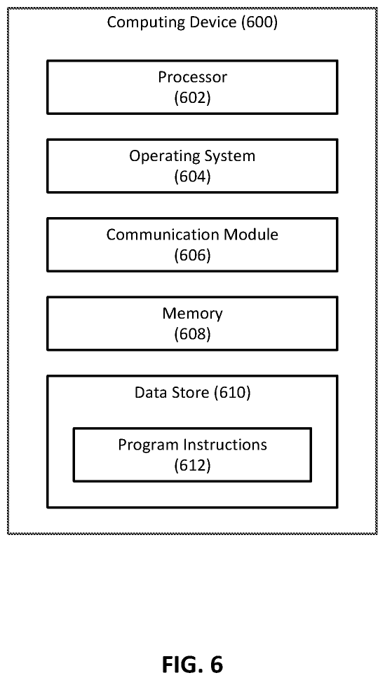

FIG. 6 illustrates selected components of an example computing device 600 that may be used to perform any of the techniques as variously described in the present disclosure, in accordance with an embodiment of the present disclosure. In various implementations, computing device 600 may be a network system or a network node. As shown in FIG. 6, computing device 600 includes a processor 602, an operating system 604, an interface module 606, memory 608, and data store 610. Processor 602, operating system 604, interface module 606, memory 608, and data store 610 may be communicatively coupled. In various embodiments, additional components (not illustrated, such as a display, communication interface, input/output interface, etc.) or a subset of the illustrated components can be employed without deviating from the scope of the present disclosure.

Processor 602 may be designed to control the operations of the various other components of computing device 600. Processor 602 may include any processing unit suitable for use in computing device 600, such as a single core or multi-core processor. In general, processor 602 may include any suitable special-purpose or general-purpose computer, computing entity, or computing or processing device including various computer hardware, or firmware, and may be configured to execute instructions, such as program instructions, stored on any applicable computer-readable storage media. For example, processor 602 may include a microprocessor, a central processing unit (CPU), a microcontroller, a digital signal processor (DSP), an application-specific integrated circuit (ASIC), a Field-Programmable Gate Array (FPGA), Complex Instruction Set Computer (CISC), Reduced Instruction Set Computer (RISC), multi core, or any other digital or analog circuitry configured to interpret and/or to execute program instructions and/or to process data, whether loaded from memory or implemented directly in hardware. Although illustrated as a single processor in FIG. 7, processor 602 may include any number of processors and/or processor cores configured to, individually or collectively, perform or direct performance of any number of operations described in the present disclosure.

Operating system 604 may comprise any suitable operating system, such as UNIX®, LINUX®, MICROSOFT® WINDOWS® (Microsoft Crop., Redmond, Wash.), GOOGLE® ANDROID™ (Google Inc., Mountain View, Calif.), APPLE® iOS (Apple Inc., Cupertino, Calif.), or APPLE® OS X° (Apple Inc., Cupertino, Calif.). As will be appreciated in light of this disclosure, the techniques provided herein can be implemented without regard to the particular operating system provided in conjunction with computing device 600, and therefore may also be implemented using any suitable existing or subsequently developed platform. Computer instructions of operating system 604 may be stored in data store 610. Processor 602 may fetch some or all of computer instructions of operating system 604 from data store 610 and may load the fetched computer instructions in memory 608. Subsequent to loading the fetched computer instructions of operating system 604 into memory 608, processor 602 may execute operating system 604.

In some embodiments, processor 602 may be configured to interpret and/or execute program instructions and/or process data stored in memory 608, data store 610, or memory 608 and data store 610. In some embodiments, processor 602 may fetch program instructions from data store 610 and load the program instructions in memory 608. After the program instructions are loaded into memory 608, processor 602 may execute the program instructions.

For example, in some embodiments, program instructions 612 cause computing device 600 to implement functionality (e.g., process 300 and/or process 500) in accordance with the various embodiments and/or examples described herein. Processor 602 may fetch some or all of program instructions 612 from data store 610 and may load the fetched program instructions 612 in memory 608. Subsequent to loading the fetched program instructions 612 into memory 608, processor 602 may execute program instructions 612 such that packets for transmission are adaptively coded and scheduled as variously described herein.

Communication module 606 can be any appropriate network chip or chipset which allows for wired or wireless communication via a network, such as, by way of example, a local area network (e.g., a home-based or office network), a wide area network (e.g., the Internet), a peer-to-peer network (e.g., a Bluetooth connection), or a combination of such networks, whether public, private, or both. Communication module 606 can also be configured to provide intra-device communications via a bus or an interconnect.

Memory 608 may include computer-readable storage media configured for carrying or having computer-executable instructions or data structures stored thereon. Such computer-readable storage media may include any available media that may be accessed by a general-purpose or special-purpose computer, such as processor 602. By way of example, and not limitation, such computer-readable storage media may include non-transitory computer-readable storage media including Random Access Memory (RAM), Dynamic Random Access Memory (DRAM), Synchronized Dynamic Random Access Memory (SDRAM), Static Random Access Memory (SRAM), non-volatile memory (NVM), or any other suitable storage medium which may be used to carry or store particular program code in the form of computer-executable instructions or data structures and which may be accessed by a general-purpose or special-purpose computer. Combinations of the above may also be included within the scope of computer-readable storage media.

Data store 610 may include any type of computer-readable storage media configured for short-term or long-term storage of data. By way of example, and not limitation, such computer-readable storage media may include a hard drive, solid-state drive, Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), non-volatile memory (NVM), or any other storage medium, including those provided above in conjunction with memory 608, which may be used to carry or store particular program code in the form of computer-readable and computer-executable instructions, software or data structures for implementing the various embodiments as disclosed herein and which may be accessed by a general-purpose or special-purpose computer. Combinations of the above may also be included within the scope of computer-readable storage media. Computer-executable instructions may include, for example, instructions and data configured to cause processor 602 to perform a certain operation or group of operations. Data store 610 may be provided on computing device 600 or provided separately or remotely from computing device 600.

The following examples pertain to further embodiments, from which numerous permutations and configurations will be apparent.

Example 1 includes a computer-implemented method to adaptively code and schedule packets in a wireless network, the method including: determining number of paths between a sender and a receiver in a multipath (MP) network; determining erasure rates for each path of the paths between the sender and the receiver; determining a multipath rate; determining a coding bucket size based on the multipath rate; and determining a multipath delay for the coding bucket size and the erasure rates.

Example 2 includes the subject matter of Example 1, wherein determining the multipath delay is by solving a discrete water filling (DWF) formulation.

Example 3 includes the subject matter of Example 2, wherein a solution to the DWF formulation specifies an allocation of packets in a coding bucket over the paths that minimizes the multipath delay, wherein the coding bucket is of the coding bucket size.

Example 4 includes the subject matter of any of Examples 1 through 3, wherein the multipath rate is a lower bound to the multipath rate assuming that all packets in a coding bucket are transmitted using a worst path with a highest erasure rate, wherein the coding bucket is of the coding bucket size.

Example 5 includes the subject matter of any of Examples 1 through 4, wherein the multipath rate is a current multipath rate, the coding bucket size is a current coding bucket size, and the method further comprising updating the current multipath rate such that the updated current multipath rate is used to optimize the current coding bucket size.

Example 6 includes the subject matter of Example 5, further including: determining an updated coding bucket size based on the updated multipath rate; and determining a multipath delay for the updated coding bucket size and the erasure rates.

Example 7 includes the subject matter of Example 6, wherein determining the updated coding bucket size and determining the multipath delay for the updated coding bucket size is iterated until the coding bucket size no longer converges.

Example 8 includes the subject matter of any of Examples 1 through 7, wherein the method of Example 1 is applied to a multihop multipath (MM) network.

Example 9 includes a computer-implemented method to adaptively code and schedule packets in a wireless network, the method including: determining an erasure rate for each link of a plurality of links between a sender and a receiver in a multihop multipath (MM) network, the MM network including a plurality of hops between the sender and the receiver; determining combinations of links through the hops between the sender and the receiver; determining a multihop multipath rate; determining a coding bucket size based on the multihop multipath rate; and determining a multihop multipath delay for the coding bucket size and the erasure rates.

Example 10 includes the subject matter of Example 9, wherein determining the multihop multipath delay is by solving a discrete water filling (DWF) formulation, wherein the DWF formulation specifies an optimal path allocation of packets in a coding bucket from the sender to the receiver that maximizes a rate at the receiver, the coding bucket being of the coding bucket size.

Example 11 includes the subject matter of any of Examples 9 and 10, wherein the multihop multipath rate is a current multihop multipath rate, the coding bucket size is a current coding bucket size, and the method further including: updating the current multihop multipath rate; determining an updated coding bucket size based on the updated multihop multipath rate; and determining a multihop multipath delay for the updated coding bucket size and the erasure rates.

Example 12 includes the subject matter of Example 11, wherein updating the current multihop multipath rate, determining the updated coding bucket size, and determining the multipath delay for the updated coding bucket size is iterated until the coding bucket size no longer converges.

Example 13 includes the subject matter of any of Examples 9 through 12, wherein the MM network includes a recoded scheme with link-by-link ACK.

Example 14 includes the subject matter of any of Examples 9 through 12, wherein the MM network includes a recoded scheme with end-to-end ACK.

Example 15 includes the subject matter of any of Examples 9 through 12, wherein the MM network includes an end-to-end coded scheme with end-to-end ACK.

Example 16 includes a system to adaptively code and schedule packets in a wireless network, the system including one or more non-transitory machine-readable mediums configured to store instructions and one or more processors configured to execute the instructions stored on the one or more non-transitory machine-readable mediums. Execution of the instructions causes the one or more processors to: determine number of paths between a sender and a receiver in a multipath (MP) network; determine erasure rates for each path of the paths between the sender and the receiver; determine a multipath rate; determine a coding bucket size based on the multipath rate; and determine a multipath delay for the coding bucket size and the erasure rates.

Example 17 includes the subject matter of Example 16, wherein to determine the multipath delay is by solving a discrete water filling (DWF) formulation.

Example 18 includes the subject matter of Example 17, wherein a solution to the DWF formulation specifies an allocation of packets in a coding bucket over the paths that minimizes the multipath delay, wherein the coding bucket is of the coding bucket size.

Example 19 includes the subject matter of Example 18, wherein a solution to the DWF formulation specifies an allocation of packets in a coding bucket over the paths that minimizes the multipath delay, wherein the coding bucket is of the coding bucket size

Example 20 includes the subject matter of any of Examples 16 through 18, wherein the multipath rate is a lower bound to the multipath rate assuming that all packets in a coding bucket are transmitted using a worst path with a highest erasure rate, wherein the coding bucket is of the coding bucket size.

Example 21 includes the subject matter of any of Examples 16 through 20, wherein the multipath rate is a current multipath rate, the coding bucket size is a current coding bucket size, and execution of the instructions causes the one or more processors to update the current multipath rate such that the updated current multipath rate is used to optimize the current coding bucket size.

Example 22 includes the subject matter of Example 21, wherein execution of the instructions causes the one or more processors to: determine an updated coding bucket size based on the updated multipath rate; and determine a multipath delay for the updated coding bucket size and the erasure rates.

Example 23 includes the subject matter of Example 22, wherein to determine the updated coding bucket size and determine the multipath delay for the updated coding bucket size is iterated until the coding bucket size no longer converges.

Example 24 includes a system to adaptively code and schedule packets in a wireless network, the system including one or more non-transitory machine-readable mediums configured to store instructions and one or more processors configured to execute the instructions stored on the one or more non-transitory machine-readable mediums. Execution of the instructions causes the one or more processors to: determine an erasure rate for each link of a plurality of links between a sender and a receiver in a multihop multipath (MM) network, the MM network including a plurality of hops between the sender and the receiver; determine combinations of links through the hops between the sender and the receiver; determine a multihop multipath rate; determine a coding bucket size based on the multihop multipath rate; and determining a multihop multipath delay for the coding bucket size and the erasure rates.

Example 25 includes the subject matter of Example 24, wherein to determine the multihop multipath delay is by solving a discrete water filling (DWF) formulation, wherein the DWF formulation specifies an optimal path allocation of packets in a coding bucket from the sender to the receiver that maximizes a rate at the receiver, the coding bucket being of the coding bucket size.

Example 26 includes the subject matter of any of Examples 24 and 25, wherein the multihop multipath rate is a current multihop multipath rate, the coding bucket size is a current coding bucket size, and execution of the instructions causes the one or more processors to: update the current multihop multipath rate; determine an updated coding bucket size based on the updated multihop multipath rate; and determine a multihop multipath delay for the updated coding bucket size and the erasure rates.

Example 27 includes the subject matter of Example 26, wherein to update the current multihop multipath rate, determine the updated coding bucket size, and determine the multipath delay for the updated coding bucket size is iterated until the coding bucket size no longer converges.

Example 28 includes the subject matter of any of Examples 24 through 27, wherein the MM network includes a recoded scheme with link-by-link ACK.

Example 29 includes the subject matter of any of Examples 24 through 27, wherein the MM network includes a recoded scheme with end-to-end ACK.

Example 30 includes the subject matter of any of Examples 24 through 27, wherein the MM network includes an end-to-end coded scheme with end-to-end ACK.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A computer-implemented method to adaptively code and schedule packets in a wireless network, the method comprising:
determining number of paths between a sender and a receiver in a multipath (MP) network;
determining erasure rates for each path of the paths between the sender and the receiver;
determining a multipath rate;
determining a coding bucket size based on the multipath rate; and
determining a multipath delay for the coding bucket size and the erasure rates.

2. The computer-implemented method of claim 1, wherein determining the multipath delay is by solving a discrete water filling (DWF) formulation.

3. The computer-implemented method of claim 2, wherein a solution to the DWF formulation specifies an allocation of packets in a coding bucket over the paths that minimizes the multipath delay, wherein the coding bucket is of the coding bucket size.

4. The computer-implemented method of claim 1, wherein the multipath rate is a lower bound to the multipath rate assuming that all packets in a coding bucket are transmitted using a worst path with a highest erasure rate, wherein the coding bucket is of the coding bucket size.

5. The computer-implemented method of claim 1, wherein the multipath rate is a current multipath rate, the coding bucket size is a current coding bucket size, and the method further comprising updating the current multipath rate such that the updated current multipath rate is used to optimize the current coding bucket size.

6. The computer-implemented method of claim 5, further comprising:
determining an updated coding bucket size based on the updated multipath rate; and
determining a multipath delay for the updated coding bucket size and the erasure rates.

7. The computer-implemented method of claim 6, wherein determining the updated coding bucket size and determining the multipath delay for the updated coding bucket size is iterated until the coding bucket size no longer converges.

8. The computer-implemented method of claim 1, wherein the method of claim 1 is applied to a multihop multipath (MM) network.

9. A computer-implemented method to adaptively code and schedule packets in a wireless network, the method comprising:
determining an erasure rate for each link of a plurality of links between a sender and a receiver in a multihop multipath (MM) network, the MM network including a plurality of hops between the sender and the receiver;
determining combinations of links through the hops between the sender and the receiver;
determining a multihop multipath rate;
determining a coding bucket size based on the multihop multipath rate; and
determining a multihop multipath delay for the coding bucket size and the erasure rates.

10. The computer-implemented method of claim 9, wherein determining the multihop multipath delay is by solving a discrete water filling (DWF) formulation, wherein the DWF formulation specifies an optimal path allocation of packets in a coding bucket from the sender to the receiver that maximizes a rate at the receiver, the coding bucket being of the coding bucket size.

11. The computer-implemented method of claim 9, wherein the multihop multipath rate is a current multihop multipath rate, the coding bucket size is a current coding bucket size, and the method further comprising:
updating the current multihop multipath rate;
determining an updated coding bucket size based on the updated multihop multipath rate; and
determining a multihop multipath delay for the updated coding bucket size and the erasure rates.

12. The computer-implemented method of claim 11, wherein updating the current multihop multipath rate, determining the updated coding bucket size, and determining the multipath delay for the updated coding bucket size is iterated until the coding bucket size no longer converges.

13. The computer-implemented method of claim 9, wherein the MM network includes a recoded scheme with link-by-link ACK.

14. The computer-implemented method of claim 9, wherein the MM network includes an end-to-end coded scheme with end-to-end ACK.

15. A system to adaptively code and schedule packets in a wireless network, the system comprising:
one or more non-transitory machine-readable mediums configured to store instructions; and
one or more processors configured to execute the instructions stored on the one or more non-transitory machine-readable mediums, wherein
execution of the instructions causes the one or more processors to determine number of paths between a sender and a receiver in a multipath (MP) network;
determine a multipath rate;
determine a total delay of each path of the paths between the sender and the receiver;
determine a coding bucket size based on the multipath rate; and
determine a multipath delay for the coding bucket size and the erasure rates.

16. The system of claim 15, wherein the multipath delay is determined using a discrete water filling (DWF) formulation.

17. The system of claim 16, wherein a solution to the DWF formulation specifies an allocation of packets in a coding bucket over the paths that minimizes the multipath delay, wherein the coding bucket is of the coding bucket size.

18. The system of claim 15, wherein the multipath rate is a lower bound to the multipath rate assuming that all packets in a coding bucket are transmitted using a worst path with a highest erasure rate, wherein the coding bucket is of the coding bucket size.

19. The system of claim 17, wherein the multipath rate is a current multipath rate, the coding bucket size is a current coding bucket size, and execution of the instructions further causes the one or more processors to:
update the current multipath rate;
determine an updated coding bucket size based on the updated multipath rate; and
determine a multipath delay for the updated coding bucket size and the erasure rates.

20. The system of claim 19, wherein update the current multipath rate, determine the updated coding bucket size, and determine the multipath delay for the updated coding bucket size is iterated until the coding bucket size no longer converges.
